(19) United States
(12) Patent Application Publication
(10) Pub. No.: US 2012/0008628 A1
(43) Pub. Date: Jan. 12, 2012

(54) NETWORK COMMUNICATION APPARATUS, COMMUNICATION METHOD, AND INTEGRATED CIRCUIT

(76) Inventors: Yasuhiro IWAI, Osaka (JP); Akihiro Ebina, Kyoto (JP)

(21) Appl. No.: 13/170,517

(22) Filed: Jun. 28, 2011

(30) Foreign Application Priority Data
Jun. 28, 2010 (JP) 2010-146912

(51) Int. Cl. H04L 12/56

(52) U.S. Cl. 370/392

(57) ABSTRACT

A network communication apparatus connected to a network for communication using Internet Protocol version 6 (IPv6) addresses includes: a communication control unit configured to generate an IPv6 address of the network communication apparatus, and generate a packet including the generated IPv6 as a source IP address; and a communication interface unit configured to transmit the packet generated by the communication control unit. The communication control unit generates the IPv6 address by including communication to information in an interface ID in the IPv6 address, and the communication information includes information indicating a dynamically changeable communication environment between the network communication apparatus and another apparatus connected in the network.

### BACKGROUND OF THE INVENTION

(1) Field of the Invention

The present invention relates to a network communication apparatus which is connected to a network in which Internet Protocol version 6 (IPv6) addresses for address management in the network are used. The IPv6 is a communication protocol that is one of underlying techniques of the Internet etc.

(2) Description of the Related Art

An IPv6 address used in the IPv6 technique that is a standard technique for the next generation Internet consists of 128 bits. The significant 64 bits of the IPv6 address are referred to as an address prefix. In general, the significant 64 bits are assigned by a router apparatus using a Router Advertisement (RA) protocol.

The least significant 64 bits of the IPv6 address are referred to as an interface ID that is an identifier having an EUI-64 format or a random identifier defined in the Privacy Extensions for Address Configuration in IPv6 (RFC3041).

The original purpose of the IPv6 address is to enable unique identification of a corresponding one of network apparatuses which participate in an IPv6 network. However, each of Patent Reference 1 (Japanese Patent Publication No. 4335149) and Patent Reference 2 (Japanese Patent Publication No. 4052522) discloses a technique of adding other useful information than the identification information of a network apparatus to the least significant 64 bits of the interface ID.

Patent Reference 1 discloses a technique for identifying a network apparatus using the IPv6 address. More specifically, Patent Reference 1 discloses a technique for identifying the type of the network apparatus using device ID information recorded on a remaining unused area other than a bit area for a particular purpose in a company ID area in an interface ID area in the EUI-64 ID format.

Patent Reference 2 discloses an IPV6 address including an interface ID including the number indicating apparatus type information of a network apparatus, and a technique for embedding, to a part of the interface ID, position information (the name of a building, the floor of the building, the name of the zone including the building, etc.) of the network apparatus.

### SUMMARY OF THE INVENTION

Home network management entails a problem. A home network is assumed here which includes a television apparatus and a Hard Disk Drive (HDD) recorder connected via a wireless Local Area Network (LAN).

In addition, it is assumed that the television apparatus and the wireless LAN router is connected using a wired LAN, and that the HDD recorder and the wireless LAN router is connected using a wireless LAN.

In the case of making access from a television apparatus to a video content accumulated in an HDD recorder via a network in such a home network, the television apparatus cannot recognize, for example, that a wireless LAN segment is included in a connection area.

This is because information indicating a communication protocol for a physical layer such as a wireless LAN is lost when the information passes through a router or a HUB. For this reason, the television apparatus cannot recognize the communication rate and communication capability of the other network apparatus such as the HDD recorder than the apparatus itself even when exerting its error check function. Accordingly, in the case of occurrence of an error such as a decrease in the image quality of the video to be displayed on a television screen, it is difficult to analyze and identify the cause of the error.

In order to solve the aforementioned problem, the present invention has been conceived with an aim to provide a network communication apparatus which is connected to a network for communication using IPv6 addresses and is capable of easily notifying a communication partner of information relating to a dynamically changeable communication environment.

In order to solve the above-described conventional problem, a network communication apparatus according to a first aspect of the present invention is connected to a network for communication using an Internet Protocol version 6 (IPv6) address, and includes: a communication control unit configured to generate an IPv6 address of the network communication apparatus, and generate a packet including the generated IPv6 address as a source IP address; and a communication interface unit configured to transmit the packet generated by the communication control unit, wherein the communication control unit is configured to generate the IPv6 address by including communication information in an interface ID of the IPv6 address, and the communication information includes information indicating a dynamically changeable communication environment between the network communication apparatus and another apparatus connected to the network.

With this structure, the network communication apparatus can embed the communication information indicating the dynamically changeable communication environment into the IPv6 address of the apparatus itself. Furthermore, the network communication apparatus can generate the packet having a source address that is the IPv6 address and transmit the packet to the other apparatus via the network.

Accordingly, even when a relay apparatus that is the other apparatus such as a router, a HUB, or the like is involved in the communication between the network communication apparatus and the communication partner, the communication partner can easily obtain at least the information indicating the dynamically changeable communication environment between the network communication apparatus and the other apparatus, from the IPv6 address that is the source IP address in the received packet.

In other words, the network communication apparatus in the first aspect of the present invention can notify the communication partner of the information relating to the dynamically changeable communication environment only using a known framework without using any additional communication protocol.

In addition, in the network communication apparatus according to the first aspect of the present invention, the communication information may include, as the information indicating the communication environment, information that is determined according to communication capabilities of at least two of the network communication apparatus, the other apparatus, and a communication medium that is used for the communication between the network communication apparatus and the other apparatus.

With this structure, the network communication apparatus can embed the communication information determined according to the communication capabilities of the network communication apparatus and the like into the source IP address in the packet, and transmit the packet. In other words, the network communication apparatus can easily notify the communication partner of the information useful for the communication partner.

In addition, in the network communication apparatus according to the first aspect of the present invention, the communication information may include at least one of (a) a rate of communication between the network communication apparatus and the other apparatus, (b) a communication protocol of a physical layer in the communication between the network communication apparatus and the other apparatus, and (c) a test result of a network between the network communication apparatus and the other apparatus, the communication rate, the communication protocol, and the network test result being the information determined according to the communication capabilities of the at least two of the network communication apparatus, the other apparatus, and the communication medium.

With this structure, it is possible to embed various kinds of information such as a communication rate etc. into the source IP address in the packet, and transmit the packet. In other words, the network communication apparatus can easily notify the communication partner of the various kinds of information useful for the communication partner.

In addition, in the network communication apparatus according to the first aspect of the present invention, the other apparatus may be a relay apparatus which relays communication with another network communication apparatus connected to the network.

With this structure, the network communication apparatus can easily notify the communication partner of the information useful for the communication partner via the relay apparatus.

In addition, in the network communication apparatus according to the first aspect of the present invention, the communication interface unit may be further configured to receive a packet that is transmitted from a communication partner connected via the relay apparatus, and the network communication apparatus may further include a communication application unit configured to obtain communication information including information indicating a dynamically changeable communication environment between the communication partner and the relay apparatus, from an IPv6 address of the communication partner which is a source IP address indicated in the packet received by the communication interface unit, and generate connection information indicating a connection state between the network communication apparatus and the communication partner, based on the obtained communication information.

With this structure, the network communication apparatus can generate the connection information from the communication information included in the source IP address in the packet which is transmitted from the communication partner.

More specifically, the communication information includes at least the information indicating the dynamically changeable communication environment between the communication partner and the relay apparatus. For this reason, the network communication apparatus can generate, for example, the connection information indicating the protocol and/or rate of the communication between the communication partner and the relay apparatus such as the router that is directly connected to the communication partner. As a result, it is possible to notify a user of the details of the connection information by, for example, displaying the generated connection information on a display unit such as a display panel.

In addition, the network communication apparatus according to the first aspect of the present invention may further include a storage unit configured to store an IPv6 address of the other apparatus that is the relay apparatus, wherein the communication application unit may be configured to read out the IPv6 address of the communication partner from the storage unit in response to an instruction for generating the connection information, and generate the connection information based on the communication information obtained from the read-out IPv6 address of the communication partner.

With this structure, processing involving generation of the connection information is performed at the time when, for example, the connection information is required according to an instruction from the user. In other words, the efficiency of the processing involving generation of the connection information is increased, and thus the overall efficiency of the whole processing in the network communication apparatus is increased.

In addition, a network communication apparatus according to a second aspect of the present invention may communicate with, as a communication partner, the network communication apparatus according to any one of the aforementioned aspect with or without options, and may include: a communication interface unit configured to receive a packet generated by the communication partner; and a communication application unit configured to obtain the communication information which is included in the IPv6 address of the communication partner which is a source IP address indicated in the packet received by the communication interface unit, and generate connection information indicating a connection state between the network communication apparatus and the communication partner, based on the obtained communication information.

With this structure, the network communication apparatus can obtain the information relating to the dynamically changeable communication environment for the communication partner, from the source IP address in the packet which is transmitted from the communication partner. In addition, the network communication apparatus can generate, from the obtained information, the connection information indicating the connection state with the communication partner.

In other words, with the network communication apparatus, it is possible to obtain the information relating to the dynamically changeable communication environment for the communication partner without using any additional communication protocol, and to generate the connection information indicating the communication connection state with the communication partner.

In addition, a network communication apparatus according to the second aspect of the present invention may communicate with the communication partner via a relay apparatus, and the communication application unit may be configured to obtain the communication information that is information including at least one of (a) a rate of communication between the communication partner and the relay apparatus, (b) a communication protocol of a physical layer in the communication between the communication partner and the relay apparatus, and (c) a test result of a network between the communication partner and the relay apparatus, and generate the connection information based on the obtained communication information, the communication information being included in the IPv6 address of the communication partner.

In addition, the present invention can also be realized as a communication method including the unique processes performed by the network communication apparatus in any one of the aforementioned aspects of the present invention. In addition, the present invention can also be realized as a program for causing a computer to execute the respective processes of the communication method, and as a recording medium on which the program is recorded. Furthermore, the program can be distributed via communication media such as the Internet, recording media such as DVDs and/or the like.

In addition, the present invention can be implemented as an integrated circuit including the unique structural elements of the network communication apparatus in any one of the aforementioned aspects of the present invention.

The present invention makes it possible to provide a network communication apparatus which is connected to a network for communication using IPv6 addresses and is capable of easily notifying a communication partner of the information indicating a dynamically changeable communication environment. In this way, if a communication error occurs, it is possible to easily analyze and identify the cause of the error.

### FURTHER INFORMATION ABOUT TECHNICAL BACKGROUND TO THIS APPLICATION

The disclosure of Japanese Patent Application No. 2010-146912 filed on Jun. 28, 2010 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a schematic diagram showing a configuration of a home network according to an embodiment of the present invention;

FIG. 2 is a diagram showing a first example of a structure of an IPv6 address according to the embodiment of the present invention;

FIG. 3 is a diagram showing a second example of a structure of an IPv6 address according to the embodiment of the present invention;

FIG. 4 is a diagram showing a third example of a structure of an IPv6 address according to the embodiment of the present invention;

FIG. 5 is a block diagram showing main structural elements of a television apparatus according to the embodiment of the present invention;

FIG. 6 is a block diagram showing main structural elements of a home server apparatus according to the embodiment of the present invention;

FIG. 7 is a flowchart of processes in generation of an IPv6 address performed by a network communication apparatus according to the embodiment of the present invention;

FIG. 8 is a diagram showing a first example of a structure of a packet that is generated and transmitted by the network communication apparatus according to the embodiment of the present invention;

FIG. 9A is a diagram showing an example of a communication sequence for notifying an IPv6 address according to the embodiment of the present invention;

FIG. 9B is a diagram showing an example of a communication sequence for notifying an IPv6 address according to the embodiment of the present invention;

FIG. 10 is a flowchart indicating an example of analysis of an IPv6 address according to the embodiment of the present invention;

FIG. 11A is a diagram showing an example of connection information according to the embodiment of the present invention;

FIG. 11B is a diagram showing another example of connection information according to the embodiment of the present invention; and

FIG. 12 is a block diagram showing main structural elements of a television apparatus that includes an address storage unit according to the embodiment of the present invention.

### DESCRIPTION OF THE PREFERRED EMBODIMENT

An embodiment of the present invention is described below with reference to the drawings.

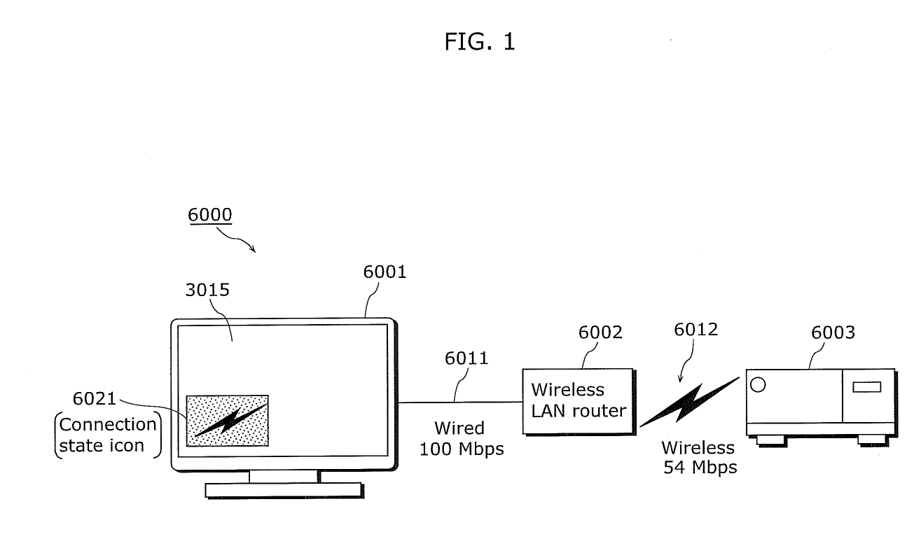

FIG. 1 is a schematic diagram showing a configuration of a home network according to this embodiment of the present invention.

As shown in FIG. 1, a home network 6000 in this embodiment includes a television apparatus 6001, a wireless LAN router 6002, and a home server 6003.

The home network 6000 is an IPv6 network. In other words, the television apparatus 6001 and the home server 6003 communicates with each other using the IPv6 addresses. Each of the television apparatus 6001 and the home server 6003 may have a communication function using IPv4 addresses, but no descriptions for this case is provided because such a communication function does not relate to the scope of the present invention.

In this embodiment, the television apparatus 6001 and the wireless LAN router 6002 are connected using a wired LAN 6011 of 100 Mbps. In addition, the home server 6003 and the wireless LAN router 6002 are connected using a wireless LAN 6012 of 54 Mbps.

The television apparatus 6001 has a display unit 3015 such as a flat panel display. As shown in FIG. 1, the television apparatus 6001 can display, on the display unit 3015, a connection state icon 6021 indicating a connection state.

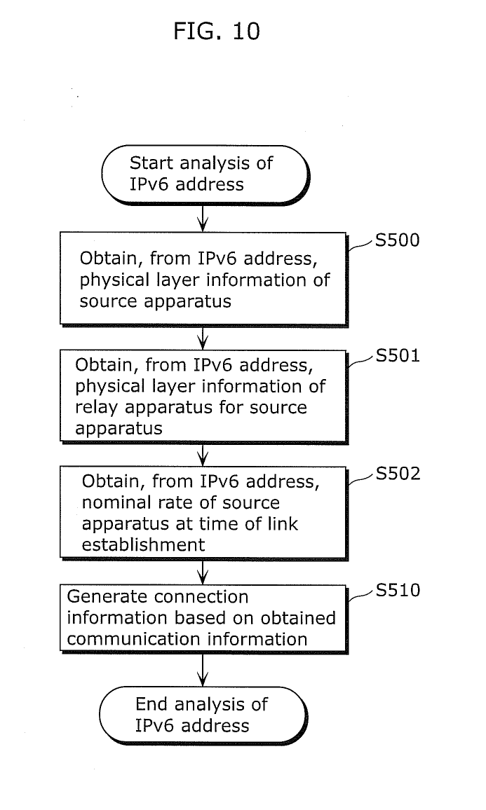

More specifically, the television apparatus 6001 generates the connection state icon 6021 indicating the connection state between the television apparatus 6001 and the home server 6003, using the information that is obtained from the source IP address in the packet that is transmitted from the home server 6003. Details of the processing involving the generation of the connection state icon 6021 will be described later with reference to FIG. 10.

The home server 6003 can stream video contents to the television apparatus 6001 via the wireless LAN router 6002. The home server 6003 is implemented as, for example, an HDD recorder.

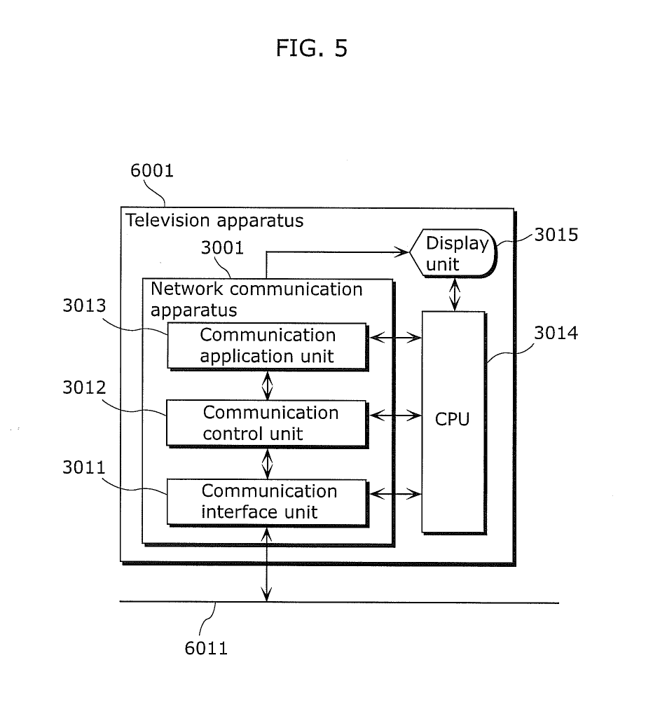

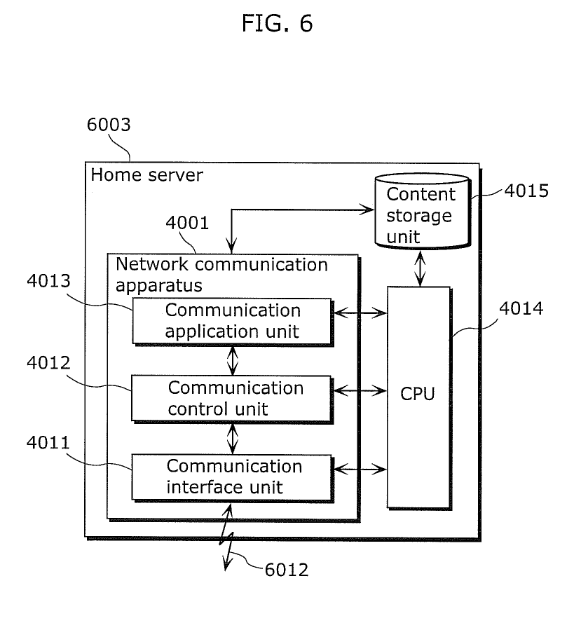

In addition, each of the television apparatus 6001 and the home server 6003 includes a network communication apparatus according to this embodiment of the present invention. The structure of the network communication apparatus will be described later with reference to FIG. 5 and FIG. 6.

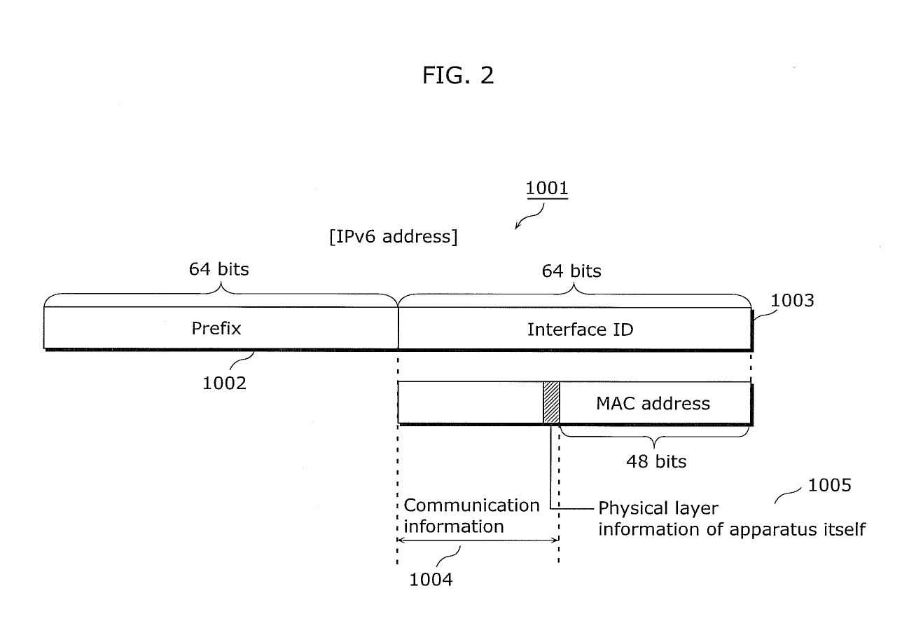

FIG. 2 is a diagram showing a first example of a structure of an IPv6 address according to Embodiment of the present invention.

Here, the IPv6 address 1001 is 128 bits in total and consists of a prefix 1002 of 64 bits and an interface ID 1003 of 64 bits.

In general, a prefix 1002 is distributed from a router using an RA protocol or a DHCPv6 protocol.

In other words, in this embodiment, each of the television apparatus 6001 and the home sever 6003 receives the same prefix 1002 from the wireless LAN router 6002.

According to the conventional scheme, the interface ID 1003 is an identifier having an EUI-64 format or a randomized identifier defined in the Privacy Extensions for Address Configuration in IPv6 (RFC3041).

As shown in FIG. 2, the IPv6 address 1001 in this embodiment includes the communication information 1004 in the interface ID 1003. The communication information 1004 includes the physical layer information of an apparatus itself 1005 which is the information about the physical layer information in the apparatus itself.

In other words, each of the television apparatus 6001 and the home server 6003 generates the IPv6 address 1001 of the apparatus itself including the physical layer information of an apparatus itself 1005.

In addition, each of the television apparatus 6001 and the home server 6003 can embed, in the IPv6 address 1001 of the apparatus itself, various kinds of information other than the physical layer information of an apparatus itself 1005. More specifically, in this embodiment, the information indicating the dynamically changeable communication environment is embedded into the communication information 1004.

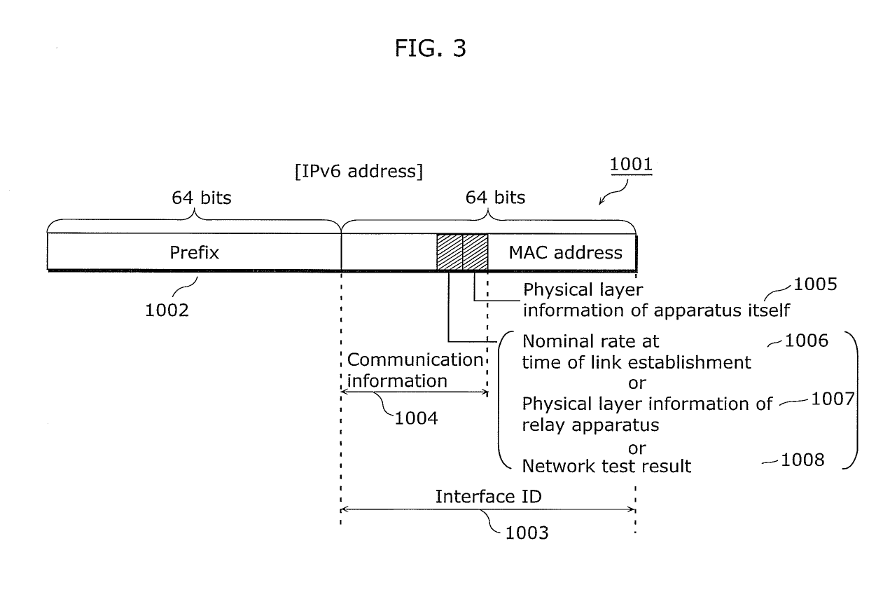

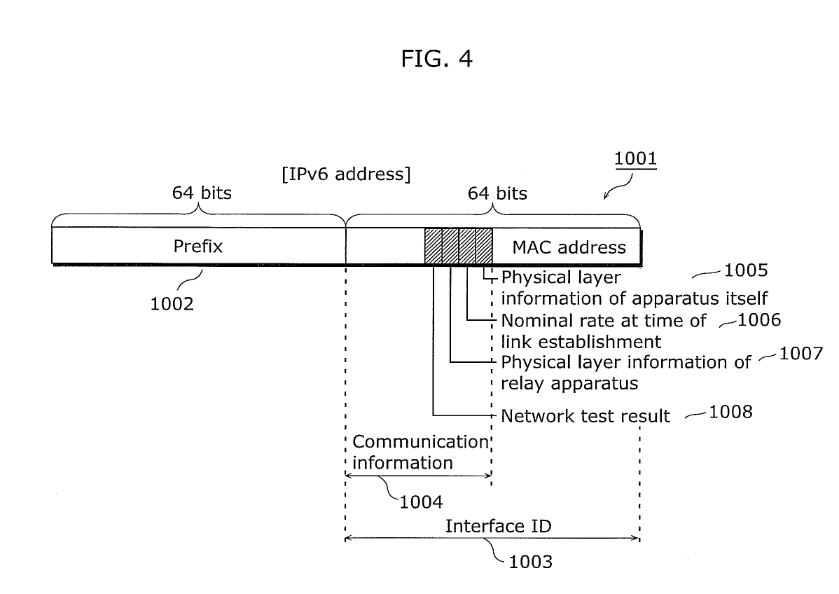

FIG. 3 is a diagram showing a second exemplary structure of the IPv6 address 1001 according to this embodiment of the present invention. FIG. 4 is a diagram showing a third exemplary structure of the IPv6 address 1001 according to this embodiment of the present invention.

As shown in FIG. 3, each of the IPv6 addresses 1001 generated by the television apparatus 6001 and the home server 6003 in this embodiment includes, for example, at least one of a nominal rate at the time of link establishment 1006, a physical layer information of a relay apparatus 1007, and a network test result 1008, in addition to the physical layer information of an apparatus itself 1005. Such information items are included in the communication information 1004 that is part of the interface ID 1003 of the IPv6 address 1001.

In addition, as shown in FIG. 4, each of the IPv6 addresses 1001 generated by the television apparatus 6001 and the home server 6003 in this embodiment includes, in the communication information 1004 that is part of the interface ID 1003, all the information items 1006 to 1008 in addition to the physical layer information of an apparatus itself 1005.

It is to be noted that the “relay apparatus” in the drawings and the Claims of the present application is an apparatus which relays packets between the network communication apparatus and the communication partner, and thus is the relay apparatus that is directly connected to (or immediately upstream of) the network communication apparatus.

For example, the relay apparatus for the television apparatus 6001 is the wireless LAN router 6002, and the relay apparatus for the home server 6003 is the wireless LAN router 6002.

A network is assumed which includes two apparatuses of a router A and a router B involved in the communication between the television apparatus 6001 and the home server 6003, in which the television apparatus 6001 and the router A are directly connected to each other, and in which the home sever 6003 and the router B are directly connected to each other. In other words, packets transmitted from the television apparatus 6001 are received by the router A, the router B, and the home server 6003 sequentially in this listed order.

In this case, the relay apparatus for the television apparatus 6001 is the router A, and the relay apparatus for the home server 6003 is the router B.

In addition, each of the various kinds of information items (1006, 1007, and 1008) of a corresponding one of the communication network apparatuses is information relating to the communication between the apparatus itself and the relay apparatus for the apparatus itself.

For example, the IPv6 address 1001 generated by the television apparatus 6001 includes at least one of (a) the nominal rate at the time of link establishment 1006 between the television apparatus 6001 and the wireless LAN router 6002, (b) the physical layer information of a relay apparatus 1007 in the communication between the television apparatus 6001 and the wireless LAN router 6002, and (c) the network test result 1008 that is the test result of the network between the television apparatus 6001 and the wireless LAN router 6002.

The physical layer information of an apparatus itself 1005 is, for example, a wired LAN protocol such as information indicating 10BaseT, 100BaseTX, or 1000BaseT. Or, the physical layer information of an apparatus itself 1005 is, for example, a wireless LAN protocol such as information indicating IEEE802.11b, IEEE802.11g, or IEEE802.11a, or IEEE802.11n. The same is true of the physical layer information of a relay apparatus 1007.

In the IPv6 address 1001 generated by the television apparatus 6001 according to this embodiment, the physical layer information of an apparatus itself 1005 is, for example, “100BaseTX”, and the physical layer information of a relay apparatus 1007 is, for example, “1000BaseT”.

In addition, in the IPv6 address 1001 generated by the home server 6003, both of the physical layer information of an apparatus itself 1005 and the physical layer information of a relay apparatus 1007 are, for example, “802.11g”.

In addition, the nominal rate at the time of link establishment 1006 is a nominal transmission rate that is determined at the time when a communication link is established between the apparatus itself and the relay apparatus. For example, it is assumed that the apparatus itself and the relay apparatus are connected using a wired LAN, that the physical layer information of the apparatus itself is 100BaseTx, and that the physical layer information of the relay apparatus is 1000BaseT. In this case, the nominal transmission rate 100 Mbps that is selected through auto-negotiation is the nominal rate at the time of link establishment 1006.

It is to be noted that the nominal rate at the time of link establishment 1006 may be 100 Mbps, for example, depending on the quality of a LAN cable used, even when both of the apparatus itself and the relay apparatus have communication capability for 1000BaseT.

In other words, the information shown as the nominal rate at the time of link establishment 1006 is exemplary information indicating the dynamically changeable communication environment, and is exemplary information determined according to the communication capabilities of at least two of the apparatus itself, the other apparatus (the wireless LAN router 6002 in this case), and the communication medium (the LAN cable in this case).

In addition, in the case where the apparatus itself and the relay apparatus are connected to each other using a wireless LAN, the nominal transmission rate that is selected according to a signal strength and/or a noise level is the nominal rate at the time of link establishment 1006 (the nominal transmission rate is, in an exemplary case of 802.11g, one of the eight options of 54, 48, 36, 24, 18, 12, 9, and 6 Mbps).

In other words, in this case, the nominal rate at the time of link establishment 1006 is determined according to the communication capability at the time of the communication.

In addition, another exemplary case is assumed in which each of the home server 6003 and the relay apparatus supports the protocols “802.11a” and “802.11g”. In this case, in the IPv6 address 1001 generated by the home server 6003, the physical layer information of an apparatus itself 1005 and the physical layer information of a relay apparatus 1007 indicate, for example, “802.11a and 802.11g”, respectively.

In this case, for example, the home server 6003 selects one of the “802.11a” and “802.11g” which corresponds to an available band.

In other words, the home server 6003 and the relay apparatus use the selected one of the protocols “802.11a” and “802.11g”.

As described above, each of the information indicated by the physical layer information of an apparatus itself 1005 and the information indicated by the physical layer information of a relay apparatus 1007 is information indicating the communication protocol for the physical layer in the communication between the home sever 6003 and the relay apparatus. This information is exemplary information indicating a dynamically changeable communication environment.

In addition, the network test result 1008 is, for example, the information indicating the result of transmitting a Packet Internet Groper (Ping) packet from the apparatus itself to the relay apparatus. For example, a response time of the Ping packet from the wireless LAN router 6002 to the television apparatus 6001 is illustrated as the network test result 1008 that is embedded in the IPv6 address 1001 of the television apparatus 6001 by the television apparatus 6001.

In addition, in an exemplary case where the LAN cable which connects the television apparatus 6001 and the wireless LAN router 6002 is disconnected, the television apparatus 6001 can detect the disconnection based on, for example, a change in the impedance of the LAN cable. As the result, information indicating the “disconnection” is included in the communication information 1004 as the network test result 1008.

In other words, the information shown as the network test result 1008 is exemplary information indicating the dynamically changeable communication environment, and is exemplary information determined according to the communication capabilities of at least two of the apparatus itself, the other apparatus (the wireless LAN router 6002 in this case), and the communication medium (the LAN cable in this case).

FIG. 5 is a block diagram showing main structural elements of a television apparatus 6001 according to this embodiment of the present invention. FIG. 5 shows the structural elements relating to processes performed by the network communication apparatus 3001, and does not show other structural elements such as a digital TV decoder unit.

As shown in FIG. 5, the television apparatus 6001 in this embodiment includes a network communication apparatus 3001, a CPU 3014, and a display unit 3015.

The network communication apparatus 3001 is intended to transmit and receive packets to and from the home server 6003. The network communication apparatus 3001 is, for example, capable of receiving a video content that is transmitted from the home server 6003.

More specifically, the network communication apparatus 3001 includes a communication interface unit 3011, a communication control unit 3012, and a communication application unit 3013.

The communication interface unit 3011 is a processing unit for transmitting and receiving packets, and is connected to a wired LAN 6011 in this embodiment. The communication interface unit 3011 is implemented as, for example, a LAN controller in wireless LAN.

The communication control unit 3012 is a processing unit for generating an IPv6 address 1001 of the apparatus itself and generating a packet including the IPv6 address 1001 as the source IP address. More specifically, the communication control unit 3012 is capable of generating the IPv6 address 1001 as shown in each of FIG. 2 to FIG. 4.

In addition, the communication control unit 3012 takes a role of receiving and processing the packet received by the communication interface unit 3011 and passing the packet to the communication application unit 3013. The communication control unit 3012 is implemented as, for example, a TCP/IP stack in the OS.

Here is an exemplary case where the home server 6003 that is the communication partner of the television apparatus 6001 does not need the information relating to the communication environment between the television apparatus 6001 and the wireless LAN router 6002. In this case, the communication control unit 3012 of the television apparatus 6001 does not need to have a function of generating an IPv6 address 1001 including the communication information 1004.

The communication application unit 3013 is a processing unit for obtaining the communication information 1004 including the information indicating the dynamically changeable communication environment for the source apparatus (such as the home server 6003), from the IPv6 address 1001 that is the source IP address in the packet passed from the communication control unit 3012. The communication application unit 3013 is further capable of generating connection information indicating a connection state between the network communication apparatus 3001 and the source apparatus, based on the obtained communication information 1004.

As shown in FIG. 1, the generated connection information is displayed on the display unit 3015 as a connection state icon 6021.

The communication application unit 3013 is implemented using, for example, a browser and the HTTP protocol.

The respective processing units of the network communication apparatus 3001 are controlled by the CPU 3014.

The CPU 3014 is a control unit for controlling the overall operations performed by the television apparatus 6001. The operations performed by the network communication apparatus 3001 are controlled by the CPU 3014 as described above. The control unit which controls the overall operations by the television apparatus 6001 may be provided separately from the CPU 3014.

As described above, the display unit 3015 is, for example, a flat panel display, and is capable of displaying the video content obtained by the network communication apparatus 3001 and displaying the connection information generated by the network communication apparatus 3001.

Here, for example, it is also possible to implement the communication interface unit 3011 and the communication control unit 3012 as a single integrated circuit in the network communication apparatus 3001.

FIG. 6 is a block diagram showing main structural elements of the home server 6003 according to this embodiment of the present invention. FIG. 6 shows the structural elements relating to processes performed by the network communication apparatus 4001, and does not show other structural elements such as a unit for reproducing video data.

As shown in FIG. 6, the home server 6003 in this embodiment includes a network communication apparatus 4001, a CPU 4014, and a content storage unit 4015.

The network communication apparatus 4001 is intended to transmit and receive packets to and from the television apparatus 6001. For example, the network communication apparatus 4001 is capable of streaming video contents in response to a request from the television apparatus 6001. The network communication apparatus 4001 has the same basic structural elements and functions as those of the network communication apparatus 3001 of the television apparatus 6001.

More specifically, the network communication apparatus 4001 includes a communication interface unit 4011, a communication control unit 4012, and a communication application unit 4013.

The communication interface unit 4011 is a processing unit for transmitting and receiving packets, and is connected to a wireless LAN 6012 in this embodiment. The communication interface unit 4011 is implemented as, for example, a wireless LAN controller in a wireless LAN 6012.

The communication control unit 4012 is a processing unit for generating an IPv6 address 1001 of the apparatus itself and generating a packet including the IPv6 address 1001 as the source IP address. More specifically, as in the case of the communication control unit 3012, the communication control unit 4012 is capable of generating the IPv6 address 1001 as shown in each of FIG. 2 to FIG. 4.

In addition, the communication control unit 4012 takes a role of receiving and processing the packet received by the communication interface unit 4011 and passing the packet to the communication application unit 4013. The communication control unit 4012 is implemented as, for example, a TCP/IP stack in the OS.

The communication application unit 4013 is a processing unit for processing the packet passed from the communication control unit 4012. The communication application unit 4013 is implemented using, for example, a browser and the HTTP protocol. The respective processing units of the network communication apparatus 4001 are controlled by the CPU 4014.

Here, it is also possible to cause the communication application unit 4013 in the network communication to generate the connection information based on the communication information 1004 obtained from the source IP address in the packet received from the communication control unit 4012.

The CPU 4014 is a control unit for controlling the overall operations performed by the home server 6003. The operations performed by the network communication apparatus 4001 are controlled by the CPU 4014 as described above. The control unit which controls the overall operations performed by the home server 6003 may be provided separately from the CPU 4014.

The content storage unit 4015 is a storage apparatus capable of recording video contents, and is implemented as, for example, an HDD. The network communication apparatus 4001 reads out a video content from the content storage unit 4015 in response to the request from the television apparatus 6001, and transmits the video content to the television apparatus 6001.

Here, for example, it is also possible to implement the communication interface unit 4011 and the communication control unit 4012 as a single integrated circuit in the network communication apparatus 4001.

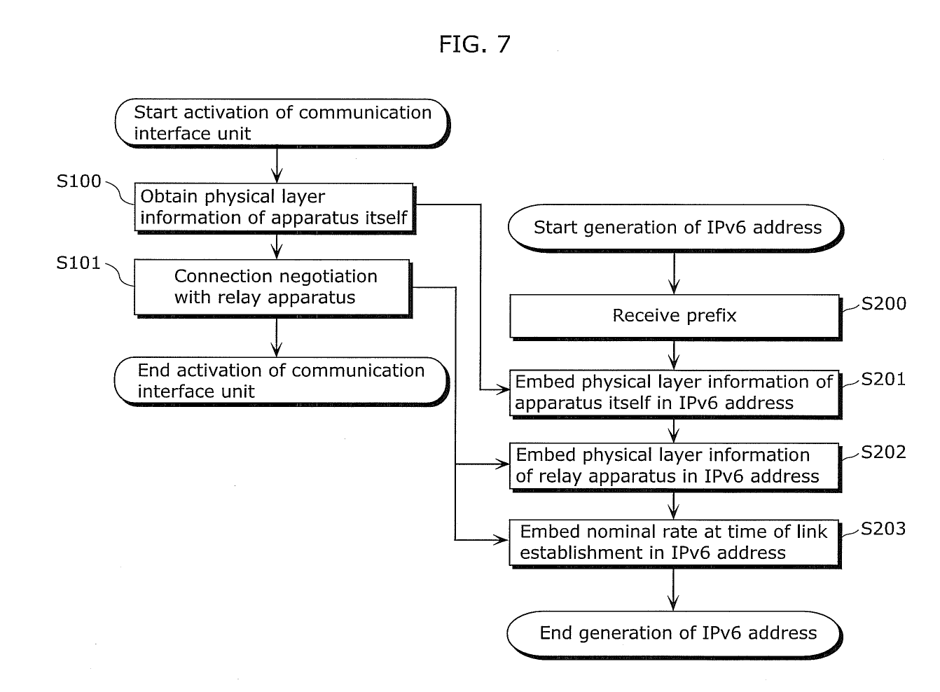

With reference to FIG. 7 to FIG. 10, the operations performed by the television apparatus 6001 and the home server 6003 including the above-described structural elements are described focusing on the flow of processes performed by the network communication apparatuses (3001 and 4001).

FIG. 7 is a flowchart of processes in generation of an IPv6 address performed by the network communication apparatus according to this embodiment of the present invention.

With reference to FIG. 7, a description is given of a flow of processes in the generation of the IPv6 address 1001 performed by the network communication apparatus 4001. In this embodiment, the network communication apparatus 3001 is capable of generating an IPv6 address 1001 by performing the same processes.

First, upon the activation of the communication interface unit 4011, the physical layer is validated. The communication control unit 4012 obtains the physical layer information of the communication interface unit 4011 which is available when the physical layer is validated (S100).

Next, the network communication apparatus 4001 performs negotiation about the connection with the relay apparatus (S101). In this embodiment, the negotiation corresponds to the connection process between the network communication apparatus 4001 and the wireless LAN router 6002. In the case of communication using a wired LAN 6011, the negotiation corresponds to a linkup via LAN.

The communication control unit 4012 obtains the physical layer information of the wireless LAN router 6002 and the nominal rate at the time of link establishment which are available at and after the time of the completion of the connection negotiation (S101).

This completes the processing for the activation of the communication interface unit 4011.

In addition, the communication control unit 4012 generates the IPv6 address 1001 according to the procedure from S200 to S203.

More specifically, the communication control unit 4012 obtains a prefix 1002 (see FIG. 1, for example) from the wireless LAN router 6002 via the communication interface unit 4011 (S200).

Next, the communication control unit 4012 embeds various kinds of information items obtained in the aforementioned S100 and S101 into the communication information 1004 that is part of the interface ID 1003 in the IPv6 address 1001 including the prefix 1002 (S201, S202, and S203).

For example, as shown in FIG. 7, the communication control unit 4012 embeds, into the communication information 1004, the physical layer information of the apparatus itself, the physical layer information of the wireless LAN router 6002, and the nominal rate at the time of link establishment.

The above processes are performed to generate the IPv6 address 1001 including the communication information 1004 including the physical layer information of the apparatus itself.

Here, it is only necessary to embed, into the IPv6 address 1001, the communication information 1004 including the information indicating the dynamically changeable communication environment. Mores specifically, it is only necessary to embed, into the interface ID 1003 in the IPv6 address 1001, the communication information 1004 including at least one of the various kinds of information items as shown in FIG. 4 (1005 to 1008).

Here, there is no particular restriction on the order of embedding the various kinds of information items into the IPv6 address 1001, and thus any embedment order is possible.

Furthermore, the communication control unit 4012 generates a packet including the generated IPv6 address 1001 as the source IP address. The generated packet is transmitted via the communication interface unit 4011.

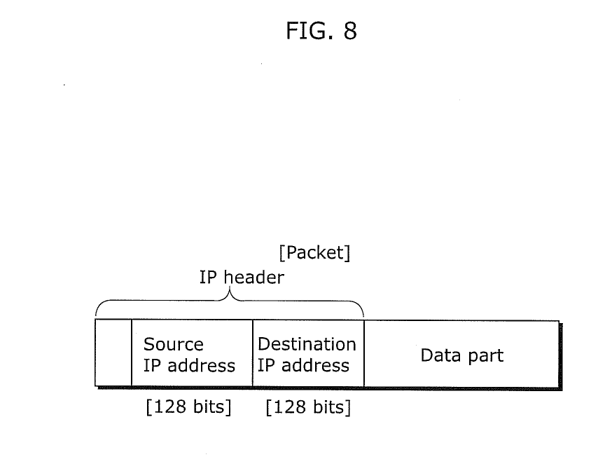

FIG. 8 is a diagram showing a first example of a structure of a packet that is generated and transmitted by the network communication apparatus according to this embodiment of the present invention.

The packet as shown in FIG. 8 is the same in structure as the packets generated by the network communication apparatus 3001 and the network communication apparatus 4001.

In other words, each of the packets which are transmitted from a corresponding one of the television apparatus 6001 and the home server 6003 includes the IPv6 address 1001 of the apparatus itself as the source IP address.

In addition, each of the IPv6 addresses 1001 of the apparatus itself generated by the television apparatus 6001 and the home server 6003 includes communication information 1004 as shown in FIG. 2 to FIG. 4. In addition, the communication information 1004 includes information indicating a dynamically changeable communication environment.

Here, when one of the television apparatus 6001 and the home server 6003 transmits a packet to the other, the IPv6 address 1001 of the other is required as the destination IP address.

For this reason, a notification of the IPv6 address 1001 is made between the television apparatus 6001 and the home server 6003.

For example, the notification is made according to a method using Universal Plug and Play (UPnP). More specifically, the home server 6003 multicasts the information such as the kind of a service that the apparatus itself provides and the IPv6 address 1001 to all the communication apparatuses within a home network 6000, at the time when the home server 6003 is connected to the home network 6000.

The multicasting enables all the communication apparatuses that support UPnP within the home network 6000 to receive the multicast information. Thus, the television apparatus 6001 can obtain the IPv6 address 1001 of the home server 6003.

In addition, the home server 6003 can obtain the IPv6 address 1001 of the television apparatus 6001 by receiving one of a packet transmitted from the television apparatus 6001 that has received the IPv6 address 1001 of the home server 6003 to the home server 6003 or a packet multicast from the television apparatus 6001 to the multicast address.

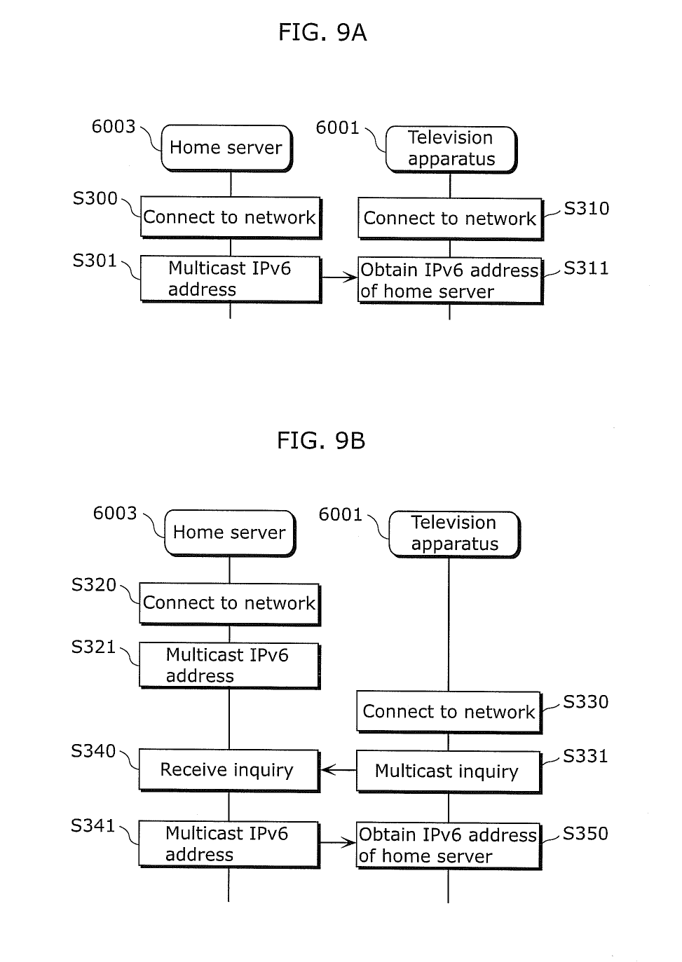

With reference to FIG. 9A and FIG. 9B, a description is given of a flow of processes relating to notification of the IPv6 address 1001 from one of the television apparatus 6001 and the home server 6003 to the other.

FIG. 9A is a diagram showing an example of a communication sequence for notifying the IPv6 address 1001 according to the embodiment of the present invention.

For example, turning on the main power source of the home server 6003 connects the home server 6003 to a network (a wireless LAN 6012) (S300).

Subsequently, the communication control unit 4012 generates the IPv6 address 1001 according to the processes as shown in FIG. 7. Furthermore, the communication control unit 4012 generates a packet having the Ipv6 address 1001 as a source IP address and the multicast address as the destination IP address. The generated packet is transmitted via the communication interface unit 4011 (S301).

It is to be noted that, the data part (see FIG. 8) of the packet includes, for example, information indicating the kind of a service (for example, video content streaming) that is provided by the home server 6003.

On the other hand, the television apparatus 6001 receives the packet from the home server 6003 when the television apparatus 6001 is already connected to the network at the time of the transmission of the packet from the home server 6003 (S301), that is, when the television apparatus 6001 is ready for the communication of the packet via the wired LAN 6011 (S310).

The network communication apparatus 3001 of the television apparatus 6001 is capable of obtaining the IPv6 address 1001 of the home server 6003 from the source IP address in the received packet (S311).

Here, when the television apparatus 6001 is connected to the network after the home server 6003 is connected thereto, the television apparatus 6001 multicasts an inquiry for the address of the apparatus to which an intended service is provided, within the network 6000 in the same manner.

FIG. 9B is a diagram showing an example of a communication sequence for notifying the IPv6 address 1001 according to the embodiment of the present invention.

Here, an exemplary case (S330) is assumed where packet communication via the wired LAN 6011 is possible after the home server 6003 is connected to the wireless LAN 6012 (S320) and the IPv6 address 1001 is notified (S321).

In this case, for example, the television apparatus 6001 transmits, to the multicast address, the inquiry packet for making an inquiry for the addresses of all the apparatuses in the home network 6000 (S331).

The home server 6003 receives the inquiry packet (S340), and multicasts the packet to the multicast address in response to the inquiry packet (S341).

The television apparatus 6001 receives the packet from the home server 6003. The network communication apparatus 3001 of the television apparatus 6001 is capable of obtaining the IPv6 address 1001 of the home server 6003 from to the source IP address in the received packet (S350).

In this way, each of the television apparatus 6001 and the home server 6003 can obtain the IPv6 address 1001 of the communication partner.

In addition, each of the television apparatus 6001 and the home server 6003 can obtain information such as the physical layer information of the communication partner from the obtained IPv6 address 1001.

FIG. 10 is a flowchart indicating an example of analysis of the IPv6 address 1001 according to this embodiment of the present invention.

For example, according to the procedure from S500 to S502, the television apparatus 6001 obtains, from the obtained IPv6 address 1001, information relating to the communication environment of the home server 6003 that is the communication partner (referred to as the “source apparatus” in FIG. 10) corresponding to the IPv6 address.

More specifically, the communication application unit 3013 obtains the IPv6 address 1001 of the home server 6003 from the communication control unit 3012. Here, the communication application unit 3013 can obtain the IPv6 address 1001 from the communication control unit 3012 using, for example, a socket interface in the OS. In other words, there is no need to modify a TCP/IP stack in an existing OS.

The communication application unit 3013 obtains the physical layer information of the home server 6003 from the interface ID 1003 of the IPv6 address 1001 of the home server 6003 obtained from the communication control unit 3012 (S500).

Furthermore, the communication application unit 3013 obtains, from the interface ID 1003, the physical layer information in the communication between the home server 6003 and the wireless LAN router 6002 (S501), and obtains the nominal rate at the time of link establishment between the home server 6003 and the wireless LAN router 6002 (S502).

Here, in the case where the interface ID 1003 includes a network test result as shown in FIG. 4, the network test result is also obtained by the communication application unit 3013. There is no particular restriction on the obtainment order of these various kinds of information items, and thus any order is possible.

In this way, the communication application unit 3013 obtains the communication information 1004 included in the IPv6 address 1001 of the home server 6003 obtained from the communication control unit 3012.

The communication application unit 3013 generates the connection information based on the obtained communication information 1004 (S510).

Mores specifically, as shown in FIG. 1, a connection state icon 6021 indicating connection information is generated and displayed on the display unit 3015 of the television apparatus 6001.

Here, the connection state icon shown in FIG. 1 indicates a wireless communication. This is known from the fact that the IPv6 address 1001 of the home server 6003 includes the information indicating the communication protocol such as “802.11g” of the wireless LAN 6012 as the physical layer information of the home server 6003.

In this way, the user can find out that the wireless LAN segment is present on the communication path between the television apparatus 6001 and the home server 6003.

In addition, not only the information indicating the physical layer information of the communication partner but also information based on other information such as the nominal rate may be generated as the connection information.

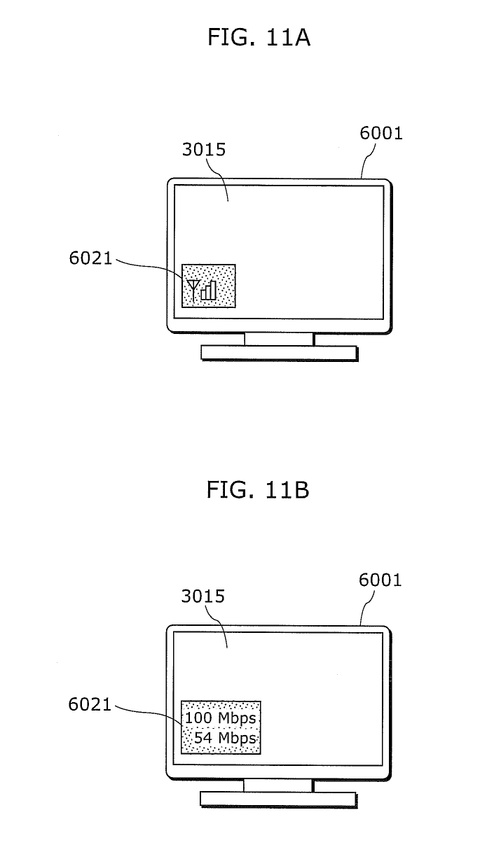

Each of FIG. 11A and FIG. 11B is a diagram showing an example of connection information according to this embodiment of the present invention.

For example, as shown in FIG. 11A, information indicating the signal strength in the wireless LAN segment may be generated as the connection information and displayed as the connection state icon 6021.

For example, as shown in FIG. 11B, information indicating the nominal rate at the time of link establishment for each of segments between the television apparatus 6001 and the home server 6003 may be generated and displayed.

More specifically, in FIG. 11B, the nominal rate (100 Mbps) at the time of link establishment between the television apparatus 6001 and the wireless LAN router 6002 is displayed on the upper column of the connection state icon 602 indicating the connection information, and the nominal rate (54 Mbps) at the time of link establishment between the wireless LAN router 6002 and the home server 6003 is displayed on the lower column of the connection state icon 602.

Here, the information indicated by the connection information may be any other kind of information, and may be, for example, information indicating a physical layer information itself such as “802.11g”. In addition, for example, the information (response time or the like) indicating the test result of the network with the wireless LAN router 6002 performed by the home server 6003 may be displayed as the connection information.

With reference to FIG. 10 to FIG. 11B, the above descriptions have been given of how the television apparatus 6001 analyzes the IPv6 address 1001 and generates the connection information. However, the home server 6003 may analyze the IPv6 address 1001 and generate the connection information in the same manner as performed by the television apparatus 6001.

In this case, it is possible to display the connection information generated by the home server 6003 on, for example, the home server 6003.

For example, it is also possible to transmit the connection information generated by the home server 6003 to the television apparatus 6001, and to display the connection information on the display unit 3015 of the television apparatus 6001.

In this way, each of the television apparatus 6001 and the home server 6003 in this embodiment of the present invention embeds at least the information indicating the dynamically changeable communication environment when generating the IPv6 address 1001 of the apparatus itself. Furthermore, each of the television apparatus 6001 and the home server 6003 generates a packet including the generated IPv6 address 1001 as the source IP address, and transmits the packet to the communication partner.

In this way, one of the television apparatus 6001 and the home server 6003 can notify the information relating to the dynamically changeable communication environment for the apparatus itself to the other without using any additional communication protocol. In other words, the network communication apparatus 3001 and the network communication apparatus 4001 can obtain the information relating to the dynamically changeable communication environment for the other.

For this reason, for example, it is possible to provide the user with useful information relating to the communication environment.

Here, an exemplary case is assumed where the user watches a video content that is transmitted from the home server 6003 and displayed on the television apparatus 6001. If an error such as degradation in the image quality of the video content occurs in this case, the user can analyze and identify the cause of the error with reference to the connection information displayed on the television apparatus 6001.

Here, the timing of generating the connection information may be any timing. For example, the television apparatus 6001 may generate the connection information when a predetermined instruction is issued from the user.

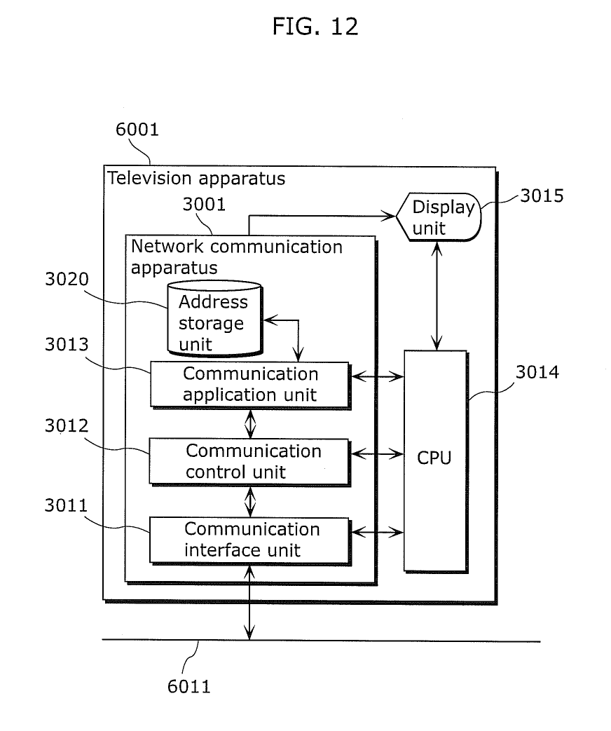

FIG. 12 is a block diagram showing main structural elements of a television apparatus 6001 that includes an address storage unit.

The television apparatus 6001 as shown in FIG. 12 includes the address storage unit 3020 for storing the IPv6 address 1001 of the communication partner obtained by the network communication apparatus 3001.

The communication application unit 3013 in the structure as shown in FIG. 12 stores the IPv6 address 1001 of the communication partner (for example, the home server 6003) obtained from the communication control unit 3012 into the address storage unit 3020 without analyzing the IPv6 address 1001.

Here is an exemplary case where the communication application unit 3013 receives the predetermined instruction for generating connection information from a remote controller (not shown) that the user operates to make the instruction. In this case, the communication application unit 3013 reads out the IPv6 address 1001 of the communication partner from the address storage unit 3020. Furthermore, the communication application unit 3013 generates the connection information based on the communication information 1004 obtained from the read-out IPv6 address 1001. The generated connection information is displayed on the display unit 3015 of the television apparatus 6001 as shown in each of FIG. 1, FIG. 11A, and FIG. 11B.

In this case, the network communication apparatus 3001 configured to generate connection information when the connection information is required can, for example, increase the efficiency of the overall processing including the process relating to generation of the connection information in the network communication apparatus 3001.

Furthermore, the network communication apparatus 3001 that generates the connection information in advance and stores the connection information in the address storage unit 3020 irrespective of the presence of an instruction from a user or the like can, for example, output the connection information upon reception of the instruction from the user or the like.

As described above, the use of the IPv6 addresses 1001 each including the communication information 1004 in the communication between a plurality of apparatuses allows end-to-end apparatuses to exchange information items relating to the communication capabilities of the apparatuses without using additional communication protocol even when a relay apparatus which is a router, a HUB, or the like is involved in the communication between the end-to-end apparatuses.

In this embodiment, the apparatuses that generate and use the IPv6 addresses 1001 including the communication information 1004 as the addresses of the apparatuses themselves are assumed to be the television apparatus 6001 and the home server 6003. However, apparatuses of any other kinds are possible as long as the apparatuses perform communication using IPv6 addresses 1001.

In other words, the apparatuses each including the network communication apparatus according to an aspect of the present invention are not limited to apparatuses of particular kinds, and thus can be implemented as various kinds of apparatuses such as home appliances, Personal Computers (PCs), and professional-use communication apparatuses.

Although only an exemplary embodiment of the present invention has been described in detail above, those skilled in the art will readily appreciate that many modifications are possible in the exemplary embodiment without materially departing from the novel teachings and advantages of this invention. Accordingly, all such modifications are intended to be included within the scope of the present invention.

### INDUSTRIAL APPLICABILITY

The present invention makes it possible to provide a network communication apparatus which is connected to a network in which communication using Internet Protocol version 6 (IPv6) addresses is performed and is capable of easily notifying a communication partner with the information indicating a dynamically changeable communication environment. Accordingly, the present invention is useful as a network communication apparatus for use in home appliances etc. which are connected to a home network in which IPv6 addresses are used.

What is claimed is:

1. A network communication apparatus which is connected to a network for communication using an Internet Protocol version 6 (IPv6) address, said network communication apparatus comprising:
a communication control unit configured to generate an IPv6 address of said network communication apparatus, and generate a packet including the generated IPv6 address as a source IP address; and
a communication interface unit configured to transmit the packet generated by said communication control unit,
wherein said communication control unit is configured to generate the IPv6 address by including communication information in an interface ID of the IPv6 address, and
the communication information includes information indicating a dynamically changeable communication environment between said network communication apparatus and another apparatus connected to the network.

2. The network communication apparatus according to claim 1,
wherein the communication information includes, as the information indicating the communication environment, information that is determined according to communication capabilities of at least two of said network communication apparatus, the other apparatus, and a communication medium that is used for the communication between said network communication apparatus and the other apparatus.

3. The network communication apparatus according to claim 2,
wherein the communication information includes at least one of (a) a rate of communication between said network communication apparatus and the other apparatus, (b) a communication protocol of a physical layer in the communication between said network communication apparatus and the other apparatus, and (c) a test result of a network between said network communication apparatus and the other apparatus, the communication rate, the communication protocol, and the network test result being the information determined according to the communication capabilities of the at least two of said network communication apparatus, the other apparatus, and the communication medium.

4. The network communication apparatus according to claim 1,
wherein the other apparatus is a relay apparatus which relays communication with another network communication apparatus connected to the network.

5. The network communication apparatus according to claim 4,
wherein said communication interface unit is further configured to receive a packet that is transmitted from a communication partner connected via the relay apparatus, and
said network communication apparatus further comprises
a communication application unit configured to obtain communication information including information indicating a dynamically changeable communication environment between the communication partner and the relay apparatus, from an IPv6 address of the communication partner which is a source IP address indicated in the packet received by said communication interface unit, and generate connection information indicating a connection state between said network communication apparatus and the communication partner, based on the obtained communication information.

6. The network communication apparatus according to claim 5, further comprising
a storage unit configured to store an IPv6 address of the other apparatus that is the relay apparatus,
wherein said communication application unit is configured to read out the IPv6 address of the communication partner from said storage unit in response to an instruction for generating the connection information, and generate the connection information based on the communication information obtained from the read-out IPv6 address of the communication partner.

7. A network communication apparatus which communicates with the network communication apparatus according to claim 1 as a communication partner, said network communication apparatus comprising:
a communication interface unit configured to receive a packet generated by the communication partner; and
a communication application unit configured to obtain the communication information which is included in the IPv6 address of the communication partner which is a source IP address indicated in the packet received by said communication interface unit, and generate connection information indicating a connection state between said network communication apparatus and the communication partner, based on the obtained communication information.

8. The network communication apparatus according to claim 7, further comprising
a storage unit configured to store the IPv6 address of the communication partner,
wherein said communication application unit is configured to read out the IPv6 address of the communication partner from said storage unit in response to an instruction for generating the connection information, and generate the connection information based on the communication information included in the read-out IPv6 address of the communication partner.

9. The network communication apparatus according to claim 7,
wherein said network communication apparatus communicates with the communication partner via a relay apparatus, and
said communication application unit is configured to obtain the communication information that is information including at least one of (a) a rate of communication between the communication partner and the relay apparatus, (b) a communication protocol of a physical layer in the communication between the communication partner and the relay apparatus, and (c) a test result of a network between the communication partner and the relay apparatus, and generate the connection information based on the obtained communication information, the communication information being included in the IPv6 address of the communication partner.

10. A communication method performed by a network communication apparatus connected to a network for communication using an Internet Protocol version 6 (IPv6) address, said communication method comprising:
generating an IPv6 address of the network communication apparatus;
generating a packet including the generated IPv6 address as a source IP address; and
transmitting the generated packet,
wherein, in said generating of the IPv6 address, the IPv6 address is generated by including communication information in an interface ID of the IPv6 address, and
the communication information includes information indicating a dynamically changeable communication environment between the network communication apparatus and another apparatus connected to the network.

11. An integrated circuit which is provided to a network communication apparatus connected to a network for communication using an Internet Protocol version 6 (IPv6) address, said network communication apparatus comprising:
a communication control unit configured to generate an IPv6 address of said network communication apparatus, and generate a packet including the generated IPv6 address as a source IP address; and
a communication interface unit configured to transmit the packet generated by said communication control unit,
wherein said communication control unit is configured to generate the IPv6 address by including communication information in an interface ID of the IPv6 address, and
the communication information includes information indicating a dynamically changeable communication environment between said network communication apparatus and another apparatus connected to the network.
